(19) United States
(12) Patent Application Publication
(10) Pub. No.: US 2003/0129384 A1
(43) Pub. Date: Jul. 10, 2003

(54) Printing blanket face and compressible layer compositions

(76) Inventor: Joseph Carl Kalchbrenner, Greer, SC (US)

Correspondence Address: PENNIE & EDMONDS LLP, 1667 K STREET NW, SUITE 1000, WASHINGTON, DC, 20006

(21) Appl. No.: 10/101,182

(22) Filed: Mar. 20, 2002

Related U.S. Application Data
(60) Provisional application No. 60/303,818, filed on Jul. 10, 2001.

(51) Int. Cl. B32B 3/26

(52) U.S. Cl. 428/317.9; 428/909

(57) ABSTRACT

The present invention relates to a printing blanket comprising a sleeve, a compressible layer including a open or closed-cell polymeric foam comprising: an acrylonitrile-butadiene copolymer, hydrogenated acrylonitrile-butadiene copolymer, carboxylated acrylonitrile-butadiene copolymer, acrylonitrile-butadiene-isoprene terpolymer, neoprene, isoprene, epoxidized isoprene, or mixtures thereof; an aromatic oil in an amount between about 5 pph and 30 pph; carbon black, which has an average particle size as measured by the iodine test of 20 to 100, between about 8 to about 70 pph; and a sulfir-based curing agent, and a printing face layer.

### CROSS-REFERENCE TO RELATED APPLICATION

This application cites priority to U.S. Provisional Patent Application No. 60/303,818, filed Jul. 10, 2001, the entire disclosure of which is hereby incorporated by express reference hereto.

### FIELD OF THE INVENTION

The present invention relates to a replaceable sleeve which may be readily mounted onto a cylindrical carrier, for example a replaceable sleeve comprising a multilayer reinforced composite. More particularly, this invention relates to a compressible layer rubber formulation a printing blanket.

### BACKGROUND OF THE INVENTION

Rubber-covered cylindrical rollers are widely used in industry for a number of applications, particularly for web or sheet handling and processing applications such as the embossing, calendering, laminating, printing and coating of paper, film, foil, and other materials. In addition to their use in web processing equipment, such rubber-covered rollers are often employed in conveyors and various office machines. Such rollers are typically comprised of a cylindrical (metal) core or other support with an outer covering of rubber, elastomer, or polymer material. However, after extended use, the covering on the rollers wears down and must be resurfaced or replaced. This typically requires that the rollers be sent to an outside source where the old surface is ground down and a new surface is applied. This is inconvenient and expensive as it requires that the processing equipment be shut down while the roller is being resurfaced or that the end user stock additional replacement rollers.

Cylindrical rollers are widely used in the printing industry. For example, printing rollers or sleeves are used in the flexographic printing industry and in the offset printing industry for providing a mountable surface for flexographic printing plates or offset printing blankets. In a typical flexographic printing press, the sleeve is mounted onto a printing cylinder using pressurized air to expand the sleeve, and the printing plates are then attached to the outer surface of the sleeve. In an offset printing process, the blanket is mounted onto a printing cylinder using pressurized air to expand the blanket.

The prior art for preparing a compressible layer for a printing blanket, as discussed in U.S. Pat. No. 5,553,541, utilizes threads as a carrier for the rubber composition and the entrapped microcells. Microspheres from are available commercially from EXPANCEL Inc., an AKZO NOBEL Co., Duluth, Ga. USA. There are grades of EXPANCEL® microspheres available with expansion temperatures in the range of 80-190° C. (176-374° F.). The different EXPANCEL® microsphere grades vary according to: expansion factor; heat resistance; particle size; and chemical and solvent resistance. The expansion when heated is due to a small amount of a hydrocarbon encapsulated by a gastight thermoplastic shell. When the microspheres are heated the thermoplastic shell softens and the hydrocarbon inside the shell increases its pressure. This results in a expansion of the spheres (typical diameter values: from 10 to 40 μm). See http://www.expancel.com/product/index.htm for other information on these microcells. See, for example, http://www.expancel.com/product/files/prod%20spec%20wu.pdf for information on the solvent resistance of various grades of microcells.

The elastomer consisting of a nitrile-butadiene copolymer has been used in this layer. The compressible or cushion layer functions to provide energy absorption, and resiliency to the blanket while allowing strain deformations to occur in the radial direction with little to no Poisson's effect occurring at the printing interface to kept the printing within the required specs. The thickness of the compressible layer is determined by the coating of threads of different thicknesses. The threads act as a carrier for the compressible microcellular rubber formulation, and form a partially inelastic layer of different physical characteristics than the remaining portion of the layers in the blanket. The threads are wound under tension, and the deposited layer typically stratifies to a thread-rich inner portion and a thread-poor outer portion. The use of threads is expensive and time consuming. Additionally, the presence of threads close below the face layer of the printing blanket may cause print imperfections due to a variation in pressure points. The apex of the threads applies more pressure to the printed surface then the area where two threads meet and adjoin each other and the inelastic nature of the threads appears to result in standing waves formed where a cylindrical printing blanket which a substantially inelastic layer, for example a thread layer, contacts the substrate.

Typically in blankets, high to medium levels of fillers and blends of fillers have been used. Typically these are low to non-reinforcing in nature. The rubber composition typically comprises polysulfide rubber. For cure systems, conventional systems are used as defined in “The Vanderbilt Rubber Handbook”. Typically the over all recipes resemble the recipes, which can be found in the section on Sponge Rubber found in “The Vanderbilts Rubber Handbook”, medium to highly loaded with non-reinforcing fillers and conventional cure systems. Such rubber compositions have poor wearability and strength.

Printing blankets must follow very exact standards in terms of thickness, wettability, expandability when mounting, compressibility, an heat generation. The one test which incorporates one or more of those parameters is a test known as compliancy, which is a test of compressibility known to those of skill in the art. Prior art blankets have a compliancy of between about 36 and 52, where the higher the number is the less a blanket is able to absorb an impact with multiple sheets of paper which may accidently be fed into the machine. The blanket thickness is generally in the range of 0.06 inches, and a paper may have a thickness of 0.007 inches. If multiple pieces of paper are drawn into a printer, the blanket is severely shocked, and the higher the compliancy value, the more of a shock is transmitted to the printer. Too low a compliancy, however, has been associated with poor print quality.

What is needed is a printing blanket assembly which has improved strength and wear characteristics, acceptable printing ability, and does not result in commercially unacceptable rogue cells, irregularities, and the like.

### SUMMARY OF THE INVENTION

This invention comprises a printing blanket comprising a sleeve; a compressible layer including a open or closed-cell polymeric foam comprising nitrile-butadiene copolymer, hydrogenated nitrile-butadiene copolymer, carboxylated nitrile-butadiene copolymer, nitrile-butadiene-isoprene terpolymer, neoprene, isoprene, epoxidized isoprene, or mixtures thereof, an aromatic oil at a rate of between about 5 pph and 30 pph, carbon black, which has an average particle size as measured by the iodine test of 20 to 100, between about 8 to about 70 ph, and a sulfur-based curing agent; and a printing face layer.

The blankets of the current invention have compressibility that is between 0.4 and 0.8 the compressibility of prior art blankets.

In a preferred embodiment, the compressible layer comprises a nitrile-butadiene-isoprene terpolymer and at least one of nitrile-butadiene copolymer, hydrogenated nitrile-butadiene copolymer, carboxylated nitrile-butadiene copolymer, neoprene, isoprene, epoxidized isoprene, SBR, or polyurethane elastomeric rubber, or a homopolymer or copolymer of butadiene, a homopolymer or copolymer of isoprene, an acrylonitrile -butadiene-isoprene terpolymer, or a mixture thereof. The compressible layer comprises at least 30% by weight of the polymeric components of the acrylonitrile-butadiene-isoprene terpolymer. In a more preferred embodiment, the compressible layer comprises at least 60% by weight of the polymeric components of the acrylonitrile-butadiene-isoprene terpolymer.

In a further preferred embodiment, the compressible layer further comprises between about 1 pph and about 20 pph of wood resins, between about 0.1 pph to about 10 pph of fatty acids, their salts, or mixtures thereof, and between about 2 pph and about 15 pph of a zinc-containing component.

In an additional embodiment, the sulfur-based curing agent forms crosslinks with the polymeric components, and wherein the sulfur-based curing agent produces greater than 50% of mono and disulfide crosslinks, with the balance being polysulfide crosslinks. The sulfur-based curing agent can also comprise sulfur at about 0.1 to about 3 pph; a dithiodimorpholine, a thiazole, a sulfenamide, or mixture thereof at about 0 1.5 to about 3.5 pph; and a thiuram, carbamate, or mixture thereof at about 1 to 2 pph.

Additionally, in one embodiment the compressible layer further comprises between about 1 pph and about 50 pph of butyl rubber, nitrile rubber, EPDM rubber, natural rubber, synthetic rubber, neoprene rubber, polysulfide rubber, polyvinyl chloride, polyurethane, or mixtures thereof. The compressible layer further comprises antioxidants, antiozonants, or a mixture thereof at between 1 to 9 pph.

In yet another embodiment, a printing blanket comprises a metallic or polymeric inner sleeve; an intermediate compressible polymeric layer overlying the sleeve, wherein the compressible layer comprises an open or closed cell polymeric foam comprising an isoprene, an acrylonitrile-isoprene-butadiene terpolymer, or a mixture thereof, a crosslinking agent, a filler, and a sulfur-containing curing agent; optionally a reinforcing layer overlying the compressible layer; and an outer polymeric printing layer; wherein printing layer comprises a nitrile-butadiene copolymer, a hydrogenated nitrile-butadiene copolymer, a carboxylated nitrile-butadiene copolymer, a nitrile-butadiene-isoprene terpolymers, neoprene, isoprene, epoxidized isoprene, butyl, halogenated butyl, fluoroelastomers, polyurethane rubbers, or blends thereof.

In a further embodiment, the compressible layer comprises expanded microspheres. The compressible layer may include about 5 pph to about 30 pph aromatic oils which are at least partially polymerized into the composition, and advantageously also between about 6 pph and about 10 pph of resins. Sulfur and sulfur-containing curing agents are added as needed, for example at a rate of between about 1 pph to about 8 pph.

Further, in some embodiments silica fiber and/or filler comprises carbon black filler with a DBP # between about 80 to about 130 in an amount between about 13 to about 50 pph. In yet another embodiment, the compressible layer includes antioxidants, antiozonants, or both, at a concentration of 1.5 to 6 pph, more preferred 2 to 4 pph, for the stabilization of the physical properties and performance over time.

In yet another embodiment, the printing face layer, the compressible layer, or both further comprise 1 to 9 pph of antioxidants, antiozonants, or a mixture thereof.

Additionally, the printing face layer may further comprise one or more of barite, silica, carbon black, and a wettability modifier.

In an additional embodiment, the compressible layer has a hardness of between about 50 and about 60, and a tensile strength of at least 1200 psi., more preferably a tensile strength of at least 1800 psi., and contains no wound thread.

In another embodiment, a printing blanket comprises a sleeve, a compressible layer including a open or closed-cell polymeric foam comprising isoprene, an acrylonitrile-isoprene copolymer, an acrylonitrile-isoprene-X terpolymer where X is another monomer, an acrylonitrile-X copolymer where X is another monomer, an an acrylonitrile-Y-X terpolymer where X and Y are monomers, nitrile-butadiene-isoprene terpolymer, or a mixture thereof, wherein the acrylonitrile content of the copolymer or terpolymer is greater than 40%, an aromatic oil at a rate of between about 5 pph and 30 pph, carbon black, a sulfur-based curing agent, and a printing face layer.

### DETAILED DESCRIPTION OF THE PREFERRED EMBODIMENTS

The present invention is related to several other co-pending applications, namely U.S. patent application Ser. No.______entitled “Printing Face Formulary,” filed on even date herewith and itself claiming priority to U.S. Provisional Patent Application No. 60/303,767, filed Jul. 10, 2001; U.S. patent application Ser. No.______, entitled “Polymeric Sleeve Used in Printing Blanket,” filed on even date herewith and itself claiming priority to U.S. Provisional Patent Application No. 60/303,804, filed Jul. 10, 2001; and U.S. patent application Ser. No.______, entitled “Spray Coating Method of Producing Printing Blankets,” filed on even date herewith and itself claiming priority to U.S. Provisional Patent Application No. 60/303,803, filed Jul. 10, 2001, each of the entire disclosures of which are hereby incorporated herein by express reference hereto.

The invention relates to forming a printing blanket by applying on a primed sleeve a compressible layer and/or a reinforcing layer, and a printing face layer. The invention more particularly relates to new rubber formulations for one or more of the aforesaid layers.

The compressible layer may comprise of an open or closed-cell polymeric foam. The cell structure of the foam, may be created with suitable chemical blowing agents such as magnesium sulfate, hydrated salts, hydrazides such as p-toluene sulfonyl hydrazide and p,p-oxybisbenzene sulfonyl hydrazide, and carbonamides such as 1,1′-azobisformamide, nitrate, nitrite, bicarbonate and carbonate salts. Still another preferred method of forming the compressible layer includes the incorporation of microcapsules.

The other ingredients to the compressible layer rubber formula such as reinforcing fillers, processing oils, and cross-linking systems all are integral in providing the final physical performance properties of the mixture as it is cured into it's final form as a product. Prior art consists of blended carbon black grades. Blends of fillers, specifically carbon blacks, is not recommended. Without being bound to theory, it is believed that there is negative synergy between multiple filler components.

The compressible layer rubber compound for printing blankets of the present invention provide high strength and low heat generation that are key to longevity of the performance.

In one embodiment, this compressible layer comprises a composition formed from a nitrile-butadiene copoylmer, hydrogenated nitrile-butadiene copolymer, carboxylated nitrile-butadiene copolymer, nitrile-butadiene-isoprene terpolymers, neoprene, isoprene, epoxidized isoprene, SBR, or any of the polyurethane elastomeric rubbers, or blends of such. The cell structure of the compressible layer may be created with suitable chemical blowing agents such as magnesium sulfate, hydrated salts, hydrazides such as p-toluene sulfonyl hydrazide and p,p-oxybisbenzene sulfonyl hydrazide, and carbonamides such as 1,1′-azobisformamide, nitrate, nitrite, bicarbonate and carbonate salts. Still another preferred method of forming the compressible layer includes the incorporation of microcapsules, for example microcells.

In another embodiment, a compressible layer is applied to a sleeve and a reinforcing layer comprising a threaded or non-thread polymeric layer consisting of a nitrile-butadiene copoylmer, hydrogenated nitrile-butadiene copolymer, carboxylated nitrile-butadiene copolymer, nitrile-butadiene-isoprene terpolymers, neoprene, isoprene, epoxidized isoprene, SBR, or any of the polyurethane elastomeric rubbers, or blends of such, is applied by spreading, spraying, or extruding over the compressible layer. The reinforcing layer is designed in composition, via polymeric composition or reduction in cell density versus the compressible layer, to posses physical properties of higher hardness, static modulus, dynamic modulus as compared to the compressible layer. The compressible layer benefits from and is structurally strengthened by the addition of the reinforcing layer. Like the compressible layer, the solvated polymeric and/or rubber components and any fillers are applied to the printing blanket by electrostatic or conventional spraying.

In one embodiment the rubber compound comprises Butadiene, Isoprene, an acrylonitrile-butadiene-isoprene terpolymer, or a mixture thereof. The butadiene and/or isoprene can be in the form of a copolymer or terpolymer, which may be either random or block. A preferred embodiment comprises at least 30%, more preferably at least 60%, of the acrylonitrile-butadiene-isoprene terpolymer, beneficially admixed with butadiene or copolymer thereof, isoprene or copolymer thereof, or a mixture thereof. The acrylonitrile content of the terpolymer provides oil and solvent resistance. A preferred acrylonitrile -butadiene-isoprene terpolymer comprises 10 to 60% acrylonitrile, preferably between about 20 to 50% acrylonitrile, more preferably between about 30 to 40% each of acrylonitrile and butadiene, and the balance isoprene. A preferred acrylonitrile-butadiene-isoprene terpolymer is DNI201 (™) available commercially from Zeon Chemical Co. of Louisville, Ky.

In another preferred embodiment, the compressible layer comprises isoprene, an acrylonitrile-isoprene copolymer, an acrylonitrile-isoprene-X terpolymer where X is another monomer, an acrylonitrile-X copolymer where X is another monomer, an an acrylonitrile-Y-X terpolymer where X and Y are monomers, or a mixture thereof. Beneficially, the acrylonitrile content of the copolymer or terpolymer is greater than 40%. Preferred copolymers which are available commercially include ZEON 1031 and NITRIFLEX N386B. Without being bound by theory, it is believed that the above described terpolymers have excellent physical properties but, because of the acrilonitrile content, there is adequate chemical resistance such that polysulfides polymers need not be added as a separate component to the formulation.

In one embodiment, the compressible layer includes a mixture of the above terpolymer and nitrile rubber, where the ratio of the terpolymer to nitrile can be 10:1 to 1:10, preferably between about 4:1 to about 1:4.

Other components and additives are beneficially added to the composition. For example, oils, preferably aromatic oil with a high number of hydroxyl groups, for example polyester phthalate processing oil such as is commercially available from C.P.Hall of Chicago as P-900 (™), which are at least partially polymerized into the composition during processing, are beneficially added at a rate of between about 5 pph and 30 pph, preferably at a rate of between about 15 pph and about 20 pph. Resins, for example wood resins, are beneficially added at a rate of between about 1 pph and about 20 pph, preferably at a rate of between about 5 pph and about 10 pph. Two step reactive resins, for example AKROCHEM P-87 (™) are also preferred. Modifiers, for example fatty acids or their salts, i.e., stearic acid or zinc stearate, are beneficially added at between about 0.1 pph to about 10 pph, preferably between about 0.5 pph to about 3 pph. Additional zinc, or other crosslinking agent, can be added at a rate of between about 2 pph and about 15 pph, for example between about 6 pph and about 10 pph. Sulfur and sulfur-containing curing agents are added as needed, for example at a rate of between about 1 pph to about 8 pph. Pph means parts by weight in 100 parts of the base polymer(s).

The filler can be any type normally used in the art. A preferred filler comprises reinforcing carbon black fillers which have particle size as measured by the Iodine # of 20 to 100, preferred 30 to 60, more preferred 40 to 50, to provide a balance between abrasion resistance and heat build-up. The structure of the reinforcing carbon black as measured by the DBP # for best performance will be about 50 to about 150, preferred about 80 to 130, more preferred 105 to 125, to provide the best balance between tear resistance and modulus. The loading or percent of filler in the total recipe should be between about 8 to about 70 phr, preferably between about 13 to about 50 pph, more preferably about 15 pph to about 37 pph, for example about 22 pph.

The cure system can include any cure system known to one of skill in the art, such as those described in “An Efficient Vulcanization System” by “The Vanderbilt Rubber Handbook”. Preferably the cure system produces a predominance, i.e., greater than 50%, preferably greater than 70%, of mono and disulfide crosslinks which have greater thermal and mechanical stability than polysulfide crosslinks which are produced by conventional sulfur cures.

The preferred formulation, when tested according to ASTM D623 to the “Blowout Condition” on a Goodrich Flexometer (™) should preferably provide a result of 30 minutes minimum, more preferably 45 minutes minimum, most preferably 60 minutes minimum.

In one embodiment, the cure system contains: sulfur at 0.1 to 3 pph, preferably 1 to 2 pph; a primary accelerator (Dithiodimorpholine, Thiazole or Sulfenamide) at 0 to 4 pph, preferably 1.5 to 3.5 pph; and a secondary accelerator (Thiuram or Carbamate) at 0 to 3 pph, preferably 1 to 2 pph.

The preferred cure system would be considered a semi-EV system where some polysulfide crosslinks are desired to improve tear strength, adhesion, and modulus due to low levels of reinforcing filler. A lower loading of reinforcing filler is desired to reduce the heat generation, which occurs during repeated flexing or repeated compression.

Another aspect of the invention includes the addition of antioxidants and antiozonants at levels of 1 to 9 pph, preferred 1.5 to 6 pph, more preferred 2 to 4 pph, for the stabilization of the physical properties and performance over time.

The inner compressible layer and intermediate reinforcing layer can also include butyl rubber, nitrile rubber, EPDM rubber, natural rubber, synthetic rubber, neoprene rubber, polysulfide rubber, a blend of nitrile rubber and polyvinyl chloride, polyurethane, and mixtures thereof. Preferably these compounds together comprise less than 50 percent by weight of the base polymer, more preferably less than about 20% of the base polymer.

The compressible layer is placed on a blanket including but not limited to cylinders, tubes, flat blankets, blankets used for flexographic printing blankets, and liners. The replaceable blanket is made up of a combination of layers including an inner sleeve, optionally a reinforcing layer overlying the inner sleeve, an intermediate compressible polymeric layer overlying sleeve/reinforcing layer, optionally a reinforcing layer overlying the compressible layer, and an outer polymeric layer forming a working, i.e., printing, surface.

The inner sleeve can be either metallic or non-metallic, i.e., polymeric. While thin metal sleeves for use on printing cylinders have been employed in the past, more recently, printing sleeves have been developed which are comprised of polymeric materials. For example, printing sleeves are known which include laminated polymeric layers reinforced with a woven or nonwoven fabric layer. Such sleeves provide an advantage over metal rollers in that they are readily expandable for mounting on a cylinder, are seamless, and provide good structural integrity for printing operations without the damage and safety limitations of thin metal sleeves. The sleeve may have a reinforcing layer, and may have a coating or layer on the internal diameter to provide the desired friction or holding strength to the roller. The sleeve can be either a sleeve, a primed sleeve, or a sleeve with one or more coatings affixed thereto.

The compressible or cushion layer functions to provide energy absorption and resiliency to the blanket while allowing strain deformations to occur in the radial direction with little to no Poisson's effect occurring at the printing interface. This radial compressibility is needed to keep the printing within the required specs. The compressible layer may comprise of an open or closed-cell polymeric foam. One method of incorporating cells is by adding expanded and/or expandable microspheres. The number of microspheres in the rubber composition can range from about 0 to 10, preferably from about 1 to about 5 for a steady state, i.e., no gradient. Advantageously, if there is no threads in the compressible layer, the compressible layer is thicker and the compressibility of the blanket is improved for a given loading of microcells.

Advantageously, the uncured rubber may also be formulated to contain unexpanded microspheres, pre-expanded microspheres, or a combination thereof for the compressible layer spray formulation. Such microspheres are subject to undesired degradation by solvents used to liquify the rubber composition. One preferred embodiment uses a solvent Methyl Isobutyl Ketone, MIBK. In another embodiment the solvent comprises a mixture of Toluene, Ethyl Acetate and a Ketone. In a third embodiment, the solvent comprises a mixture of between 5% to 50% Methyl Amyl Ketone, preferably 10%-30%, more preferably 18%-25% where the balance is substantially MIBK. Of course, any polar organic solvent which is capable of solvating the rubber composition and which does not unduly attack microspheres can be used, especially in combination with MIBK and/or methyl amyl ketone.

The rubber of the present composition can be placed on the sleeve by thread transfer, spraying, electrostatic spraying, extrusion, substantially solventless extrusion, spread with a doctor blade or spreader, spread with rollers, or the like.

A printing face layer is applied over the compressible layer and reinforcing layer, if any. The printing face may include a closed-cell foam or solid density or mixture thereof. The printing face may include a nitrile-butadiene copolymer, a hydrogenated nitrile-butadiene copolymer, a carboxylated nitrile-butadiene copolymer, a nitrile-butadiene-isoprene terpolymers, neoprene, isoprene, epoxidized isoprene, SBR, EPDM, butyl, halogenated butyl, fluoroelastomers, or any of the polyurethane elastomeric rubbers, or blends thereof.

The printing face composition may also include fillers, wettability modifiers, basicity modifiers, crosslinkers, and the like. The solvated rubber composition may optionally include a binder capable of forming a bond with one or more particulate fillers such as barite, silica, carbon black, polysulfide rubber, microcells, and the like, such as carboxylated styrene butadiene latex, styrene-acrylic copolymer latex, acrylic latex, vinyl acrylic latex, urethane (aromatic and aliphatic), diphenylmethane diisocyanate-urethane (MDI), and toluene diisocyanate (TDI).

The one or more elastomeric rubbers useful in the present invention can include, but are not limited to: natural rubber, polyisoprene rubbers, polyisobutylene rubbers, polybutadiene rubbers, chloroprene rubbers (e.g., such as those commercially available under the tradename NEOPRENE from DuPont Chemical), nitrile rubbers (e.g., such as acrylonitrile-butadiene copolymers, or NBRs, commercially available under the tradename NIPOL from Zeon Chemicals Inc. or under the tradename PARACRIL from Uniroyal), butyl rubbers, silicone rubbers, fluorinated rubbers (e.g., such as those commercially available under the tradename Viton from DuPont Chemical), polysulfides (e.g., such as those commercially available under the tradename THIOKOL from Rohm & Haas), copolymer rubbers (e.g., random, alternating, block, multiblock, graft, multigraft, comb, star, branched, and/or dendritic copolymers comprising at least one of ethylene, propylene, butadiene, isoprene, styrene, isobutylene, and the like, fully or partially hydrogenated versions thereof, or a combination thereof, which may include, but are not limited to, EPDM, EPR, SBR, SBS, SIS, SEBS, SEPS, SEEPS, or combinations thereof), and the like, as well as mixtures or copolymers thereof. In one preferred embodiment, the one or more elastomeric rubbers comprises a nitrile rubber. In another preferred embodiment, the one or more elastomeric rubbers consists essentially of one or more nitrile rubbers.

The one or more additives and/or processing aids useful in the invention may include, but are not limited to:

organic or inorganic low molecular weight fillers and/or reinforcing agents (e.g., clay; talc; glass fibers; mica; calcium metasilicate; barium sulfate; zinc sulfide; lithopone; silicates; silicon carbide; diatomaceous earth; carbonates such as calcium carbonate and magnesium carbonate; silica such as that commercially available under the tradename HISIL from PPG Industries; particulate carbonaceous materials such as graphite, carbon black (e.g., commercially available from Cabot), cotton flock, natural bitumen, and cellulose flock; micro balloons such as glass and ceramic; fly ash; or the like; or combinations thereof), preferably silica and/or carbon black, more preferably, where carbon black is used, a mixture of grades may be used, but preferably a single grade of carbon black is used, more preferably the Cabot N550 grade of carbon black;

tackifying additives (e.g., wood resins, such as coumarone-indene, lignin resins, and/or those commercially available under the tradename FF from Hercules);

phenol-formaldehyde resins, such as those commercially available under the tradename P-87 from Akrochem; and the like, or combinations thereof);

homogenization agents (e.g., plasticizing organic oils, such as those aromatic oils commercially available under the tradename SUNDEX from Sun, di(butoxy-ethoxy-ethyl) formal, which is available under the tradename TP-90B from Rohm & Haas, or the like, or a mixture thereof;

oligomeric/polymeric oils, such as polyester phthalate, which is available commercially under the tradename PLASTHALL from CP Hall, mixed phthalate oils, such as those commercially available under the tradename PALANTIOL from BASF, or the like, or a mixture thereof; or the like; or a combination thereof);

formability enhancers (e.g., factices or vulcanized oils, such as crosslinked vegetable oil, which can be obtained commercially under the tradename RHENOPRENE from Bayer);

reaction controlling compounds (e.g., retarding agents, such as those commercially available under the tradename PVI from Vanderbilt);

pigments (e.g., white pigments, such as (rutile) titania which is commercially available from DuPont or, in combination with nitrile rubber, from Polymerics; blue pigments, such as 12973 Blue, which is commercially available from Harwick; and the like; or combinations thereof);

surface active compounds (e.g., silane compounds, such as organosilanes commercially available, inter alia, from Degussa);

and the like; or a mixture thereof.

The crosslinking agent according to the invention may include one or more compounds that facilitate the crosslinking/vulcanization of the elastomeric rubber component and may advantageously include, but is not limited to:

accelerators (for example, organic sulfur-containing compounds, such as sulfenamides, e.g., mercapto-benzothiazole sulfenamide or N-tert-butylbenzothiazole sulfenamide, which are both commercially available, in combination with EPR, under the tradename RHENOGRAN from Rhein Chemie; tetraethylthiuram, which is commercially available under the tradename TETD from Akrochem; tetramethylthiuram, which is commercially available under the tradename TMTD from Akrochem; carbamide compounds, such as those commercially available under the tradename BUTYL-8; dithiodimorpholine, which is commercially available under the tradename VANAX from Vanderbilt; or the like; or a combination thereof);

activators (e.g., zinc oxide, which is commercially available, in combination with EPR, under the tradename RHENOGRAN from Kenrich; magnesium oxide, which is commercially available under the tradename MAGLITE from CP Hall and which is also useful to alter the hydrophilicity of the composition; polyethylene glycol, such as that commercially available under the tradename CARBOWAX from Union Carbide, and which is also useful to alter the hydrophilicity of the composition; or the like; or combinations thereof);

sulfur compounds (e.g., elemental sulfur or other sulfur source, such as P-80, which is commercially available from Akrochem, in combination with SBR; SPIDER SULFUR, which is commercially available from Akrochem; or the like; or a combination thereof);

acidic dispersants (e.g., organic fatty acids having a number average molecular weight below about 500, such as stearic acid or the like);

or the like; or a combination thereof.

The one or more antioxidants may include, but are not limited to, one or more of the it following, or combinations thereof:

(i) Phenol and/or alkylated monophenols;

(ii) Hydroquinones and/or alkylated hydroquinones;

(iii) Tocopherols;

(iv) Hydroxylated thiodiphenyl ethers;

(v) Bisphenol and/or alkylidenebisphenols;

(vii) O—,-and S-benzyl compounds;

(vii) Hydroxybenzylate malonates;

(viii) Aromatic hydroxybenzyl compounds;

(ix) Triazine compounds;

(x) Benzylphosphonates;

(xi) Acylaminophenols;

(xii) Ascorbic acid (Vitamin C);

(xiii) Aminic antioxidants such as hydroquinoline; phenylenediamine; and/or derivatives or mixtures thereof;

(xiv) UV-absorbers and light stabilizers;

(xv) Phosphites and phosphonites;

(xvi) Hydroxylamines;

(xvii) Thiosynergists such as dilauryl thiodipropionate, distearyl thiodipropionate, and mixtures thereof;

(xviii) Peroxide scavengers such as esters of-thiodipropionic acid, for example the lauryl, stearyl, myristyl or tridecyl esters; mercaptobenzimidazole or the zinc salt of 2-mercaptobenzimidazole; zinc 2-mercapto-toluimidazole; zinc dibutyldithiocarbamate; dioctadecyl disulfide; pentaerythritol tetrakis(-dodecylmercapto)propionate; and mixtures thereof;

or mixtures thereof.

In a preferred embodiment, the at least one antioxidant is selected from the group consisting of zinc 2-mercapto-toluimidazole, bis-phenol, phenol, phenylenediamine, hydroquinoline, and any combination thereof.

The compressible layer composition according to the invention may advantageously include about 100 parts of one or more elastomeric rubbers; one or more additives and/or processing aids; a crosslinking agent; and one or more antioxidants.

In a preferred embodiment, the one or more compressible layer elastomeric rubbers comprises at least one nitrile rubber, preferably at least one nitrile rubber copolymer having an acrylonitrile content from about 25% to about 41%, more preferably from about 30% to about 40%, most preferably from about 33% to about 37%. In this preferred embodiment, the at least one compressible layer nitrile rubber copolymer possesses an average acrylonitrile content from about 33% to about 40%, preferably from about 33% to about 37%. In a more preferred embodiment, the one or more compressible layer elastomeric rubbers comprises a terpolymer made from acrylonitrile and butadiene monomers, and preferably also containing isoprene monomers. Preferred terpolymers contain at least about 25%, more preferably at least about 30%, of each of the monomer components. More preferably, the terpolymer comprises acrylonitrile in an amount from about 33% to about 40%, butadiene in an amount from about 30% to about 40%, and another monomer component, preferably isoprene, in an amount from about 30% to about 40%. The compressible layer elastomeric rubber may contain a mixture of rubber homopolymers or copolymers containing acrylonitrile monomers, and preferably contains at least about 50%, more preferably at least about 80%, most preferably at least about 90%, of the acrylonitrile-butadiene-isoprene terpolymer. The terpolymers give excellent mechanical properties, and the tightly controlled acrylonitrile content allows the formulation to have sufficient resistance to inks and solvents that polysulfide polymers are not needed in the formulary.

In addition to about 100 parts rubber, a compressible layer composition according to the present invention may preferably comprise: microspheres present in an amount from about 1 to about 10 pph rubber; crosslinking agents present in an amount from about 5 to about 35 pph rubber, preferably from about 8 to about 25 pph rubber, more preferably from about 10 to about 20 pph rubber; one or more antioxidants present in an amount not more than about 15 pph rubber, preferably from about 0.5 to about 10 pph rubber, more preferably from about 1 to about 8 pph rubber; and additives and/or processing aids present in an amount not more than about 90 pph rubber, preferably from about 15 to about 85 pph rubber, more preferably from about 25 to about 75 pph rubber, most preferably from about 30 to about 70 pph rubber.

In preferred embodiments, a compressible layer composition according to the present invention may possess one or more of the following: a carbon black content from about 12 to about 28 pph rubber; a microsphere content from about 1 to about 10 pph rubber; a retarding agent content from about 0.1 to about 1.5 pph rubber; a resin content from about 10 to about 24 pph rubber; an oil content from about 10 to about 22 pph rubber; a phenol content from about 0.1 to about 3 pph rubber; a zinc 2-mercapto-toluimidazole content from about 0.1 to about 3 pph rubber; a phenylenediamine content from about 0.1 to about 3 pph rubber; a sulfur donor content from about 2 to about 4 pph rubber; an accelerator content from about 1 to about 7 pph rubber; a sulfur content from about 1 to about 2.5 pph rubber; a stearic acid content from about 0.1 to about 3 pph rubber; an activator content from about 5 to about 15 pph rubber; and/or a combination thereof.

In one preferred embodiment, the one or more antioxidants includes a phenolic antioxidant, a peroxide scavenger, an aminic antioxidant, or a combination thereof

Optionally, an adhesive layer may be included in a printing blanket according to the invention, in order to adhere the compressible layer to the metallic or polymeric printing sleeve.

The printing face according to the invention may advantageously include one or more elastomeric rubbers; one or more additives and/or processing aids; a crosslinking agent; and one or more antioxidants.

In a preferred embodiment, the one or more printing face layer elastomeric rubbers comprises at least one nitrile rubber copolymer having an acrylonitrile content from about 25% to about 41%, preferably from about 35% to about 40%. In this preferred embodiment, the at least one printing face layer nitrile rubber copolymer possesses an average acrylonitrile content from about 36% to about 40%. One preferred printing face layer nitrile rubber copolymer includes butadiene monomers, as well as acrylonitrile monomers, and optionally, but less preferably a few percent of one or more other comonomers. Preferably, the butadiene content of the printing face layer nitrile rubber copolymer is at least about 55%, preferably at least about 59%, more preferably from about 59% to about 61%. The printing face layer elastomeric rubber may contain a mixture of rubber homopolymers or copolymers containing acrylonitrile monomers, and preferably contains at least about 50%, more preferably at least about 80%, most preferably at least about 90%, of the acrylonitrile-butadiene copolymer.

In one embodiment, the printing face layer elastomeric rubber component comprises a mixture of nitrile rubbers. In another embodiment, the acrylonitrile content of the at least one printing face layer nitrile rubber copolymer can be from about 30% to about 37%, or the average acrylonitrile content of all the included printing face layer nitrile rubber copolymers can be from about 33% to about 37%. In still another embodiment, the one or more printing face layer elastomeric rubbers does not include an added polysulfide polymer. The acrilonitrile-butadiene copolymers or terpolymers give excellent mechanical properties, and the tightly controlled acrylonitrile content allows the formulation to have sufficient resistance to inks and solvents that polysulfide polymers are not needed in the printing face formulary.

In addition to about 100 parts rubber, a printing face layer composition according to the invention may preferably comprise: crosslinking agents present in an amount from about 5 to about 35 pph rubber, preferably from about 8 to about 25 pph rubber, more preferably from about 10 to about 20 pph rubber; one or more antioxidants present in an amount not more than about 15 pph rubber, preferably from about 0.5 to about 10 pph rubber, more preferably from about 1 to about 8 pph rubber; and additives and/or processing aids present in an amount not more than about 120 pph rubber, preferably from about 20 to about 110 pph rubber, more preferably from about 40 to about 100 pph rubber, most preferably from about 55 to about 95 pph rubber.

In these preferred embodiments, the printing face layer composition according to the present invention may possess one or more of the following: a silica content from about 12 to about 30 pph rubber; a retarding agent content from about 0.5 to about 4 pph rubber; a resin content from about 2 to about 10 pph rubber; a non-vulcanized oil content from about 10 to about 30 pph rubber; a factice content from about 10 to about 30 pph rubber; an organosilane content from about 1 to about 5 pph rubber; a pigment content from about 5 to about 25 pph rubber; a hydroquinoline content from about 0.1 to about 3 pph rubber; a zinc 2-mercapto-toluimidazole content from about content from about 0.1 to about 3 pph rubber; a phenylenediamine content from about 0.5 to about 3 pph rubber; a sulfur donor content from about 1 to about 4 pph rubber; an accelerator content from about 0.1 to about 3 pph rubber; a sulfur content from about 0.5 to about 3 pph rubber; a stearic acid content from about 0.5 to about 4 pph rubber; an activator content from about 5 to about 15 pph rubber; and/or a combination thereof.

In other embodiments, a printing face layer composition according to the present invention may comprise: crosslinking agents present in an amount from about 5 to about 35 pph rubber, preferably from about 8 to about 25 pph rubber, more preferably from about 8 to about 20 pph rubber; one or more antioxidants present in an amount not more than about 10 pph rubber, preferably from about 0.1 to about 5 pph rubber, more preferably from about 0.5 to about 3 pph rubber; and additives and/or processing aids present in an amount not more than about 85 pph rubber, preferably from about 15 to about 75 pph rubber, more preferably from about 25 to about 70 pph rubber, most preferably from about 30 to about 65 pph rubber.

In these other embodiments, the printing face layer composition according to the present invention may preferably possess one or more of the following: from about 20 to about 40 parts of a polysulfide component; from about 5 to about 20 pph of silica; from about 10 to about 30 pph of a factice; from about 0.1 to about 5 pph of a phenolic antioxidant; from about 3 to about 12 pph of pigment; from about 1 to about 10 pph of an accelerator; from about 4 to about 10 pph of a non-vulcanized oil; from about 0.1 to 1.5 pph of a retarding agent; from about 0.1 to 3 pph of stearic acid; from about 3 to about 15 pph of an activator; and/or a combination thereof.

In another preferred embodiment, the one or more printing face layer additives and/or processing aids includes a factice, at least one pigment, a retarding agent, an inorganic filler, or a combination thereof.

Optionally, the printing blanket according to the invention may contain an adhesive layer. When present, the adhesive layer composition according to the invention may advantageously include about 100 parts of one or more elastomeric rubbers; one or more additives and/or processing aids; a crosslinking agent; and one or more antioxidants.

In a preferred embodiment, the one or more adhesive layer elastomeric rubbers comprises at least one nitrile rubber copolymer having an acrylonitrile content from about 25% to about 41%, preferably from about 30% to about 35%. In this preferred embodiment, the at least one adhesive layer nitrile rubber copolymer possesses an average acrylonitrile content from about 30% to about 35%. One preferred adhesive layer nitrile rubber copolymer includes butadiene monomers, as well as acrylonitrile monomers, and optionally, but less preferably a few percent of one or more other comonomers. Preferably, the butadiene content of the adhesive layer nitrile rubber copolymer is at least about 60%, preferably at least about 65%, more preferably from about 66% to about 68%. The adhesive layer elastomeric rubber may contain a mixture of rubber homopolymers or copolymers containing acrylonitrile monomers, and preferably contains at least about 50%, more preferably at least about 80%, most preferably at least about 90%, of the acrylonitrile-butadiene copolymer.

In addition to about 100 parts rubber, an adhesive layer composition according to the present invention may preferably comprise: crosslinking agents present in an amount from about 2 to about 30 pph rubber, preferably from about 4 to about 25 pph rubber, more preferably from about 6 to about 20 pph rubber; one or more antioxidants present in an amount not more than about 10 pph rubber, preferably from about 0.1 to about 8 pph rubber, more preferably from about 0.5 to about 6 pph rubber; and additives and/or processing aids present in an amount not more than about 95 pph rubber, preferably from about 15 to about 90 pph rubber, more preferably from about 25 to about 85 pph rubber, most preferably from about 35 to about 80 pph rubber.

In preferred embodiments, the adhesive layer composition according to the present invention may possess one or more of the following: a silica content from about 20 to about 55 pph rubber; a non-vulcanized oil content from about 10 to about 30 pph rubber; an organosilane content from about 0.5 to about 3 pph rubber; a pigtnent content from about 3 to about 20 pph rubber; a bis-phenol content from about 0.5 to about 6 pph rubber; an accelerator content from about 1 to about 10 pph rubber; a sulfur content from about 0.5 to about 4 pph rubber; an activator content from about 2 to about 12 pph rubber; and/or a combination thereof.

In one embodiment, an adhesive layer according to the invention is disposed between the printing face and the compressible layer. In another embodiment, an adhesive layer according to the invention is disposed between the printing face and a reinforcing layer. In still another embodiment, an adhesive layer according to the invention is disposed between a reinforcing layer and the compressible layer. In any of these embodiments, the adhesive layer may advantageously function as an adhesive or compatibilizer for the two layers between which it is disposed.

In a preferred embodiment, the one or more adhesive layer elastomeric rubbers comprises at least one nitrile rubber copolymer having an acrylonitrile content from about 25% to about 41%, preferably from about 30% to about 37%. In this preferred embodiment, the at least one adhesive layer nitrile rubber copolymer possesses an average acrylonitrile content from about 30% to about 37%.

### EXAMPLES

The rubber composition of Example 1 was made with the formula provided in Table 1. The formulation was formed into a sheet to resemble a printing blanket layer and the properties of the formulation we compared to two comparative formulations. The formulation of the current invention provided a rubber with better physical properties than the comparative formulations. Further, the formulation was resistant to intrusion or swelling by hydrocarbons.

TABLE 1

| | | PARTS BY | |
|---|---|---|---|
| COMPOUND | TRADENAME | WEIGHT | |
| Acrylonitrile-isoprene- | NIPOL DN1201 | 100 | parts |
| butadiene terpolymer | | | |
| carbon black | N550 | 20 | parts |
| retardant | REDIMIX 4209CTP50 | 0.5 | parts |
| Tackifying processing resin/ | Wood Resin | 8 | parts |
| oil | | | |
| Aromatic oil | SUNDEX 790 | 16 | parts |
| two-step reactive resin | AKROCHEM P-87 | 7 | parts |
| Antioxidant | AGERITE SUPERFLEX G | 1 | part |
| Antioxidant | ZMTI | 1 | part |
| Antiozonant | 6PPD | 1 | part |
| Dithiomorpholine | SULFASAN R | 3 | parts |
| Thiuram | TETD (75%) | 2 | parts |
| Sulfur | | 1.5 | parts |
| Stearic acid | | 1 | part |
| Zinc oxide | | 9 | parts |

TABLE 2

| | Comparative | Comparative | |
|---|---|---|---|
| PROPERTY | Example 1 | Example 2 | EXAMPLE 1 |
| Hardness (Shore A) | 53 | 63 | 54 |
| 300% modulus, (psi) | 761 | 972 | 1559 |
| Tensile strength, (psi) | 912 | 972 | 2480 |
| Elongation to break, % | 370 | 300 | 396 |
| Tear, (ASTM 624, lbs/in) | 124 | 139 | 181 |
| Comp Set (%) | 8 | 7 | 7 |

The strength of the rubber composition is such that it is amenable for providing threadless printing blankets. The threadless printing blanket for the gapless seamless printing blanket market includes a plurality of layers, including a substantially cylindrical sleeve, a threadless compressible layer or cushion layer, optionally a threadless reinforcing layer, and a threadless printing face layer. Threads are believed to affect print quality and create undesired pressure lines in the printing face, which transfers the ink to paper at variations in intensities. A threadless blanket would be an improvement over current and prior art for print quality.

In one embodiment, the blanket contains a high modulus/low elongation sleeve. This sleeve is typically a thin 0.003″ to 0.010″ nickel alloy sleeve that has been primed with one or two primers which promote adhesion of the compressible layer onto the sleeve. This invention is not limited to metallic sleeves, however, and can be applied to ant suitable high modulus/low elongation film type substrates of non-metallic and metallic structure.

In one embodiment, a reinforcing layer or layers may be formed with a gradient in properties which structurally strengthen printing blanket, but where the rubber composition of the two layers is such that there is no substantial differences except for the density of open cells. If there is a gradient there may be no discemable boundary between the compressible layer and the reinforcing layer(s). There is therefor no boundary wherein sharp differences in physical properties create stresses, heat, or locations prone to failure. In this preferred embodiment, this gradient may be designed radially to the design of the printing cylinder.

The compressible layer and printing face layer advantageously include solvents in an amount to provide sufficient viscosity such that the elastomers can be applied to the substrate. Any solvent that will solvate the elastomers but not attack microcells, a polymeric sleeve if used, or reinforcing films such as MYLAR films if present, are useful. Some methods of applying the elastomer require other solvent properties. It is recognized that the cured printing blanket will contain substantially no solvent, and few if any of the polymeric compounds mentioned as ingredients. The compositions, and solvent concentrations if provided, are expressed as what would be found when the composition is applied to the printing blanket, before drying, curing, and vulcanization.

The compressible, reinforcing, and/or printing face layers after applying, drying, and curing, will have a modulus of elasticity beneficially less than about 900, preferably less than about 800, for example between 100 and 700.

### Example 1

### Compressible Layer Composition for use in a Printing Blanket According to the Invention.

The composition of the compressible layer of Example 1 is delineated in the table below. NIPOL DN1201 is a terpolymer containing about 35% acrylonitrile, about 33% butadiene, and about 32% isoprene.

| | EXAMPLE | |
|---|---|---|
| | 1 (PPH | COMPONENT RANGES |
| COMPONENT | RUBBER) | (PPH RUBBER) |
| NIPOL DN1201 nitrile | 100 | About 100 parts rubber |
| rubber | | |
| N550 Carbon black | 20 | From about 10 to about 40 |
| EXPANCEL microspheres | 5.5 | From about 1 to about 10 |
| Phthalimide | 0.5 | Not more than about 2 |
| FF Wood Resin | 8 | From about 2 to about 14 |
| SUNDEX 790 aromatic oil | 16 | From about 2 to about 25 |
| P-87 phenol formaldehyde | 7 | From about 1 to about 15 |
| resin | | |
| Phenol | 1 | Not more than about 3 |
| Zinc 2-mercapto- | 1 | Not more than about 3 |
| toluimidazole | | |
| Phenylenediamine | 1 | Not more than about 3 |
| Dithiodimorpholine | 3 | From about 1 to about 5 |
| BUTYL-8 carbamide | 2 | From about 0.5 to about 5 |
| compound | | |
| Tetraethylthiuram | 2 | From about 0.25 to about 4 |
| Spider Sulfur | 1.5 | From about 0.25 to about 2.5 |
| Stearic Acid | 1 | Not more than about 4 |
| Zinc Oxide (85%, | 9 | From about 2.5 to about 40 |
| KENRICH French Process) | | |

The ingredients above, except microspheres and butyl-8, were combined using a BANBURY mixer. Temperature, mixing strength, and order of addition of ingredients was controlled so that the composition was homogenized but such that there was substantially no interference with fabrication of the compressible layer via premature activation of the crosslinking or vulcanization reaction. Once the compressible layer composition of Example 1 was sufficiently mixed, a sufficient amount of an organic solvent, e.g., toluene, was added to the resultant mixture in order to facilitate deposition on, and compatibilization with, the substrate upon which the compressible layer composition was deposited (i.e., a metallic or polymeric sleeve).

The compressible layer composition of Example 1, as fabricated, exhibited a Shore A hardness of approximately 54.

Printing blankets were also fabricated incorporating the compressible layer of Example 1, as described above. A reinforcing layer, comprising the above composition without the microspheres can be disposed above or below the compressible layer of Example 1.

### Example 2

### Printing Face Composition for use in a Printing Blanket According to the Invention

The composition of the printing face layer of Example 2 is delineated in the table below. The NIPOL VT rubbers are copolymers of acrylonitrile and butadiene, each having a Mooney viscosity of approximately 80. The composition of the 380 rubber is approximately 30/70 acrylonitrile/butadiene; the composition of the 480 rubber is approximately 40/60 acrylonitrile/butadiene; and the composition of the 3380 rubber is approximately 33/67 acrylonitrile/butadiene.

| INGREDIENT | INDIVIDUAL COMPONENTS |
|---|---|
| NIPOL VT380 nitrile rubber | From about 10 to about 20 parts |
| NIPOL VT480 nitrile rubber | From about 10 to about 20 parts |
| NIPOL DN3380 nitrile rubber | From about 25 to about 50 parts |
| THIOKOL Polysulfide | From about 15 to about 45 parts |
| HISIL 233 silica | From about 2 to about 30 parts |
| RHENOPRENE C crosslinked vegeta- | From about 5 to about 40 parts |
| ble oil | |
| Stearic Acid | Not more than about 5 parts |
| NAUGAWHITE bis-phenol | Not more than about 10 parts |
| RHENOGRAN ZN0-85 (85% ZnO IN | From about 1 to about 20 parts |
| EPR) | |
| Phthalimide | Not more than about 2 parts |
| POLY-DISPERSION A(TI)D-80 (80% | Not more than about 10 parts |
| TIO2 IN NBR) | |
| 12973 Blue pigment | From about 0.5 to about 10 parts |
| RHENOGRAN MBTS-75 (75% | From about 0.5 to about 10 parts |
| sulfenamide IN EPR) | |
| tetramethylthiuram | From about 0.5 to about 5 parts |
| di(butoxy-ethoxy-ethyl)formal oil | From about 2 to about 15 parts |

The ingredients above were combined using a BANBURY and an open mill mixer. Temperature, mixing strength, and order of addition of ingredients was controlled so that the composition was homogenized but such that there was substantially no interference with fabrication of the compressible layer via premature activation of the crosslinking or vulcanization reaction.

Printing blankets were also fabricated incorporating the printing face layer of Example 2. This was accomplished by extruding the composition and disposing the composition over a compressible layer, or optionally over an adhesive layer that is disposed upon a reinforcing layer and/or the compressible layer.

### Example 3

### Printing Face Composition for use in a Printing Blanket According to the Invention.

The composition of the printing face layer of Example 3 is delineated in the table below. NIPOL 4050 is a copolymer containing approximately 40% acrylonitrile and about 60% butadiene.

| | EXAMPLE | |
|---|---|---|
| | 3 (PPH | COMPONENT RANGES |
| INGREDIENT | RUBBER | (PPH RUBBER) |
| NIPOL 4050 nitrile rubber | 100 | About 100 parts |
| DURASIL 880 Silica | 20 | From about 5 to about 50 |
| DEGUSSA SI-69 | 3 | From about 0.5 to about 6 |
| organosilane | | |
| AKROCHEM P-87 phenol | 5 | From about 2 to about 10 |
| formaldehyde resin | | |
| RHENOPRENE EPS cross- | 20 | From about 5 to about 40 |
| linked vegetable oil | | |
| PLASTHALL P-900 polyester | 20 | From about 5 to about 35 |
| phthalate oil | | |
| MAGLITE K (magnesium | 3 | Not more than about 10 |
| oxide) | | |
| AKROCHEM DQ | 1 | Not more than about 5 |
| (hydroquinoline) | | |
| VANOX ZMTI (zinc 2- | 1 | Not more than about 5 |
| mercapto-toluimidazole) | | |
| HARWICK 12973 Blue | 4 | From about 0.5 to about 10 |
| pigment | | |
| POLYMERICS 80% TiO2 | 10 | From about 2 to about 25 |
| White pigment | | |
| Phenylenediamine | 2 | Not more than about 5 |
| Dithiodimorpholine | 2 | From about 1 to about 5 |
| Tetraethylthiuram | 0.5 | From about 0.25 to about 4 |
| Pthalimide | 2 | Not more than about 2 |
| AKROCHEM P-80 sulfur | 1.5 | From about 0.5 to about 3 |
| (80% sulfur in SBR) | | |
| Stearic Acid | 2 | From about 0.5 to about 4 |
| Zinc Oxide (85% KENRICH | 5 | From about 2.5 to about 40 |
| French Process) | | |

The ingredients above were combined using a BANBURY and an open mill mixer. Temperature, mixing strength, and order of addition of ingredients was controlled so that the composition was homogenized but such that there was substantially no interference with fabrication of the compressible layer via premature activation of the crosslinking or vulcanization reaction.

Increased hydrophilicity can be advantageous in printing faces of the invention. The printing face of Example 3 shows more hydrophilic character than the printing face described in Example 2. Without being bound to theory, it is surmised that the addition of the polyester phthalate oil and the magnesium oxide co-accelerator result in the increased hydrophilicity of the composition in Example 3.

Printing blankets were also fabricated incorporating the printing face layer of Example 3. Similarly to that described in Example 2, this was accomplished by extruding the composition and disposing the composition over a compressible layer, or optionally over an adhesive layer that is disposed upon a reinforcing layer and/or the compressible layer.

### Example 4

### Adhesive Layer Composition for use in a Printing Blanket According to the Invention

The composition of the adhesive layer of Example 4 is delineated in the table below. PARACRIL BJLT M-50 is a 33/67 copolymer of acrylonitrile and butadiene.

| | EXAMPLE | |
|---|---|---|
| | 4 (PPH | COMPONENT RANGES |
| INGREDIENT | RUBBER) | (PPH RUBBER) |
| PARACRIL BJLT M-50 | 100 | About 100 parts |
| nitrile rubber | | |
| HISIL 233 silica | 40 | From about 5 to about 50 |
| DEGUSSA SI-69 | 0.8 | From about 0.5 to about 3 |
| organosilane | | |
| CARBOWAX 3350 | 3 | From about 0.5 to about 6 |
| polyethylene glycol | | |
| NAUGAWHITE bis-phenol | 2 | Not more than about 10 |
| HARWICK 12973 Blue | 3.5 | From about 0.5 to about 10 |
| pigment | | |
| DuPont R-900 (RUTILE) | 5 | From about 1 to about 20 |
| titanium dioxide | | |
| PALANTIOL 711P mixed | 15 | From about 5 to about 40 |
| 7-11 phthalate oil | | |
| RHENOGRAN ZNO-85 (85% | 3 | From about 0.5 to about 10 |
| ZnO IN EPR) | | |
| Tetraethylthiuram | 0.5 | From about 0.1 to about 3 |
| RHENOGRAN TBBS-75 | 2 | From about 0.5 to about 10 |
| (75% sulfenamide IN EPR) | | |
| AKROCHEM P-80 sulfur | 2 | From about 0.5 to about 10 |
| (80% sulfur in SBR) | | |

The ingredients above were combined using a BANBURY and an open mill mixer. Temperature, mixing strength, and order of addition of ingredients was controlled so that the composition was homogenized but such that there was substantially no interference with fabrication of the compressible layer via premature activation of the crosslinking or vulcanization reaction. Once the adhesive layer composition of Example 4 was sufficiently mixed, a sufficient amount of an organic solvent, e.g., toluene, was added to the resultant mixture in order to facilitate deposition on, and compatibilization with, the compressible layer.

Printing blankets were also fabricated incorporating the adhesive layer of Example 4. This was accomplished by depositing a thin layer of the mixed composition, including the solvent (e.g., from about 0.1 to about 5 mils thick, preferably from about 0.5 to about 3 mils thick) onto the vulcanized or partially vulcanized compressible layer (e.g., usually one that has already been deposited on a substrate printing sleeve) or onto a reinforcing layer diposed upon the compressible layer. This layer may serve as an adhesive, or at least as a compatibilizing layer, between the compressible layer or a reinforcing layer and a printing face deposited upon the adhesive layer. Alternately, the layer may serve as an adhesive, or at least as a compatibilizing layer, between the compressible layer and a reinforcing layer deposited upon the adhesive layer. The adhesive layer may be especially useful in adhering a vulcanized or partially vulcanized layer to an unvulcanized layer.

### Example 5

### Tests of Printing Blanket According to the Invention

In the printing industry that there are many factors that enter into the utility of a printing blanket. In addition to the basic properties of the layers, the blanket must have the appropriate acidity and wettability, the required stiffness but also the required compressibility, and the layer formulations must not creep or show signs of age while in operation. During typical operation, a blanket is expanded and placed on a roller, rotated at a high velocity while being coated with different ink formulations while compressing against both paper and other rollers, nips, and the like, and must be able to survive impacts when multiple pieces of printing substrate, i.e., paper, are accidentlyjammed in the small tolerances between the blanket and the roller. As a result, no printing blanket formulations can be considered useful unless they have been tested on a printer. Printing blankets using the formulations of Example 1 for the compressible layer, Example 4 for the adhesive, and either Example 2 or Example 3, were prepared using electrostatic-spray-on technology. These sleeves have no threads, and are manufactured by

providing a primed nickel sleeve;

electrostatic spraying on the compressible layer onto the nickel sleeve;

at least partially vulcanizing the compressible layer;

optionally grinding the compressible layer;

applying the adhesive over at least partially vulcanized compressible layer;

electrostatic spraying of the printing face formulary of either example 2 or example 3;

vulcanizing the rubbers in the sleeve;

grinding the printing face to a tolerance of about 1 micron.

The tests were Four-Color Catalogs printed on a SUNDAY PRESS™ available from Heidelberger Druckmaschinen AG, Heidelberg, DE. A four color test is a rigorous test as multiple rollers must act in concert to provide acceptable registration as the printing substrate passes from one roller to the next. In these tests, there was no Process Color in Unit #1, Black was in Unit #2. A print run was started with commercially available sleeves which were run for about 350,000impressions. The print operating data from the prior art commercial sleeves is shown in the table below.

Temperature

| | Unit | Compliancy | Oper. | Gear |
|---|---|---|---|---|
| Com. 1 | #2 - Upper Black | 42 | 90 | 92 |
| Com. 2 | #2 - Lower Black | 42 | 95 | 92 |
| Com. 3 | #3 - Upper Cyan | 40 | 95 | 96 |
| Com. 4 | #3 - Lower Cyan | 40 | 95 | 96 |
| Com. 5 | #4 - Up. Magenta | 41 | 95 | 97 |
| Com. 6 | #4 - Lo. Magenta | 41 | 96 | 99 |
| Com. 7 | #5 - Upper Yellow | 43 | 98 | 97 |
| Com. 8 | #5 - Lower Yellow | 43 | 98 | 99 |

The sleeves of this invention, which contained no threads and the printing face formulary of Example 2, were then installed. Printing was within 0.020″ on register and color looked good, and after warmup of about 2,000 sheets the print was of commercial quality.

The water was reduced, and the print quality improved marginally. These sleeves were consumed after 1-1.5 million impressions.

In the next test, the sleeves were gradually replaced with sleeves of the printing face formulary of Example 3. A second catalog was printed, again with 4 colors. The color was of commercial quality, but after about 400,000 impressions three of the sleeves were pulled. Two had pinholes or blisters and one had ink piling.

These three sleeves were replaced with sleeves of Example 3. Ultimately, one was on the black unit and two were on the Magenta unit. The register and color were fine and no noticeable difference was observed by the Press Crew. The sleeves ran 0.9 million impressions.

The printing face formulary of Example 2 has a tensile strength less than 1000 psi. The tensile strength of the printing face formulary of Example 3 exhibits greater than 1000 psi but less than 6000 psi tensile values.

All experimental sleeves went on easily, without need of lubricant. The tests were run at 1400 to 2700 feet per hour, and 14000-88000 impressions per hour. The following table describes the print operating data for the Sleeves with printing face formulary of Example 2 that replaced the commercial sleeves listed above, when run at 2400 feet per hour and 78000 impressions per hour, where Id. is an identification number.

Temperature

| I.D. | Unit | Oper. | Gear |
|---|---|---|---|
| 6044 | #2 - Upper Black | 98 | 99 |
| 6670 | #2 - Lower Black | 97 | 100 |
| 9432 | #3 - Lower Cyan | 101 | 100 |
| 9410 | #3 - Upper Cyan | 99 | 97 |
| 6835 | #4 - Lower Magenta | 102 | 98 |
| 9436 | #4 - Upper Magenta | 103 | 100 |
| 4447 | #5 - Upper Yellow | 100 | 101 |
| 6675 | #5 - Lower Yellow | 102 | 101 |

The temperature is recorded because it is desirable to control both gear and operating temperatures within prescribed limits. The blankets must not generate excessive heat during operation, and must be able to dissipate the heat generated.

No bustle wheels were needed and the sheet looked good. The operators mentioned that they have problems printing wide webs>52″ with commercial sleeves, where the registration on the ends varies from the rest of the sleeve on wide webs. At the time this was checked there were 500,000 impressions on the plates and the problem was not observed with the experimental sleeves. The printing was done on 50 weight paper DESPERADO™ Web Paper from Mead. The print job was a Catalog that was 44½″ wide.

We have surprisingly found that the thicker compressible layer and the relatively lower compliancy of the composition allow the locust of many points to act as independent springs. On a 57″ long Sleeve, it is estimated that the core deflects between 0.003-0.004″ from the center to the ends during high speed operation. The center deflects more than the ends. In a traditional sleeve of the prior art, to compensate for the deflection, the ends are step ground or profiled. The sleeve of the prior art includes wound inextensible thread layer that require the step grind. The new sleeves of this invention contain no such inextensible layer, that is, the nickel is inextensible but the compressible layer and the face later are 100% elastomeric. Elastomers with a 50-60 Shore A hardness are considered elastic. The compressible layer formulations contain 4.5% & 5.5% by weight microspheres. The range of microspheres can be 1-7% with the preferred being 2.5-6.0% and most preferred being 5.0-5.5%. Though these sleeves had a profiled grind of a layer, sleeves of this invention in some embodiments have been surprisingly found to not need profile grinding. The following data was obtained with sleeves of at 2407 feet per hour.

| | | Temperature (F.) | | |
|---|---|---|---|---|
| Sleeve ID | Unit | Oper. | Gear | Comments |
| 6044 | #2 - Upper Black | 97 | 97 | Job running smooth |
| 6670 | #2 - Lower Black | 98 | 101 | 90,000 impressions |
| 6816 | #3 - Upper Cyan | 97 | 100 | |
| 9432 | #3 - Lower Cyan | 101 | 100 | |
| 9436 | #4 - Upper Magenta | 103 | 101 | |
| 9435 | #4 - Lower Magenta | 103 | 104 | |
| 6675 | #5 - Upper Yellow | 103 | 102 | |
| 4447 | #5 - Lower Yellow | 101 | 103 | |

The speed of the press was increased to 2503 feet per hour (81,000 impressions per hour) and the following temperature data was obtained after 205,000 impressions and after temperature was increased 2 degrees F and then brought back down after 292,000net impressions were made.

| | | | | Temperature | |
|---|---|---|---|---|---|
| Sleeve ID | | Temperature | | @ 292,000 | |
| impressions | Unit | Oper. | Gear | Oper. | Gear |
| 6044 | #2-Upper Black | 100 | 100 | 96 | 96 |
| 6670 | #2-Lower Black | 103 | 100 | 96 | 97 |
| 6816 | #3-Upper Cyan | 98 | 101 | 98 | 99 |
| 9432 | #3-Lower Cyan | 101 | 101 | 99 | 104 |
| 9436 | #4-Upper Magenta | 105 | 101 | 105 | 100 |
| 9435 | #4-Lower Magenta | 102 | 104 | 100 | 100 |
| 6675 | #5-Upper Yellow | 104 | 101 | 104 | 100 |
| 4447 | #5-Lower Yellow | 101 | 104 | 102 | 103 |

At 379,000 impressions the temperature remained fairly stable, and washup was easy. At 500,000 impressions the #2-Upper Black sleeve blew out, and shortly thereafter the #4-Upper Magenta and #4-Lower Magenta sleeves were replaced due to pin holes. The sleeves reached 125 degrees F. after removal from the press. There was a slight registration problem after these sleeves were replaced with sleeves of the printing face formulary of Example 3, but the quality was soon commercially acceptable. The operating temperature at 2100 feet per hour (68,000 impressions per hour) were:

Temperature

| Sleeve ID | Unit | Oper. | Gear |
|---|---|---|---|
| 9441 | #2 - Upper Black | 92 | 91 |
| 6670 | #2 - Lower Black | 93 | 94 |
| 6810 | #3 - Upper Cyan | 95 | 97 |
| 9432 | #3 - Lower Cyan | 95 | 98 |
| 157 (Ex. 3) | #4 - Upper Magenta | 99 | 96 |
| 021 (Ex. 3) | #4 - Lower Magenta | 96 | 97 |
| 6675 | #5 - Upper Yellow | 100 | 97 |
| 4447 | #5 - Lower Yellow | 96 | 100 |

With these sleeves in place a new 4-color Catalog job was started using a 38# paper Drapers Gloss™ and a 46 1/4″ wide web. The 9441 sleeve was damaged during transition and was replaced. Operating conditions were:

Temperature

| Sleeve ID | Unit | Oper. | Gear |
|---|---|---|---|
| 9443 | #2 - Upper Black | 105 | 96 |
| 6670 | #2 - Lower Black | 109 | 106 |
| 6810 | #3 - Upper Cyan | 106 | 105 |
| 9432 | #3 - Lower Cyan | 112 | 105 |
| 157 (Ex. 3) | #4 - Upper Magenta | 110 | 106 |
| 021 (Ex. 3) | #4 - Lower Magenta | 96 | 95 |
| 6675 | #5 - Upper Yellow | 95 | 94 |
| 4447 | #5 - Lower Yellow | 91 | 95 |

At 247,000 impressions, the unit continued to run without problems, and operating temperatures were between 93 degrees F. and 101 degrees F., generally increasing as the unit increased. The #4-Lower Magenta gear was running at 103 degrees F., about 4 degrees hotter than the operating temperature. The remaining gear temperatures were within 2 degrees F. of the operating temperatures. Soon thereafter, several sleeves blistered and were replaced.

About 2,000,000 impressions were accumulated on the sleeve of Example 3 and the other sleeves of this invention. The print was judged to be of commercial quality and the electrostatically sprayed, no-thread sleeves of this invention were interchangeable with commercial threaded blankets.

These printing blankets with the elastomeric compositions, described in the examples, in the disclosure, and/or in the claims, are considerably stronger than the prior art blankets. As such, the strength of wound threads which were used in the prior art to apply the compressible layer and often the printing layer, is not needed. The threads provided a substantially inelastic layer. The modulus of elasticity can be made high enough such that a reinforcing layer of threads is not needed. A preferred embodiment comprises at least one layer that has a modulus of elasticity that is between about 100 pounds per square inch and 2000 pounds per square inch, preferably between about 500 pounds per square inch and about 950 pounds per square inch, more preferably between about 700 pounds per square inch and about 900 pounds per square inch. Preferably, this layer is between about 0.006 inches and 0.047 inches in thickness. This provides strength while not giving a layer that is substantially inelastic. Inelastic layers incorporated into a cylindrical printing blanket may be responsibe for standing waves being forms at the entrance where the blanket contacts a roller.

In another embodiment, a reinforcing layer can be disposed between the compressible layer and the printing face layer. This layer may be of an elastomer composition of the printing face layer or of the compressible face layer, but with added crosslinking agents, for example up to twice the curing and crosslinking agents specified for the printing face layer or of the compressible face layer, respectively. The reinforcing layer may comprise fiber that are wound or unwound and suspended in elastomer, the fibers comprising fiberglass, carbon fibers, polymeric fibers such as polyesters, natural fibers, cotton-wrapped polymeric fibers, rayon, ARAMID, MYLAR, or the like.

In another embodiment, a reinforcing layer can be a film with a modulus of elasticity of between about 1000 pounds per square inch and about 20000 pounds per square inch, preferably between about 11000 pounds per square inch and about 16000 pounds per square inch. High strength ribbons of this low elasticity film can be wound in a barber pole fashion around the printing blanket, and can be adhered to the sleeve and/or to the elastomeric layer(s) by for example an adhesive described herein. An elastomeric product may already be put on the substantially inelastic film prior to winding the film onto the substrate. This elastomeric product, preferably a printing face formulation or a compressible layer formulation with or without microcells, may be in a cured state, a partially cured but tacky state, or a substantially uncured state which may include residual solvents. The elastomeric material is beneficially facing outward so that any subsequent grinding will not affect the integrity of the film. A preferred film comprises at least one of MYLAR (™), ARAMID (™), KEVLAR (™), high density polyethylene, polyester, or other film-forming polymers with high modulus/low elongation properties known in the art.

We claims:

1. A printing blanket comprising:
a sleeve;
a compressible layer including a open or closed-cell polymeric foam comprising
an acrylonitrile-butadiene-isoprene terpolymer and optionally at least one of nitrile-butadiene copolymer, hydrogenated nitrile-butadiene copolymer, carboxylated nitrile-butadiene copolymer, neoprene, isoprene, epoxidized isoprene, SBR, or polyurethane elastomeric rubber;
an aromatic oil in an amount between about 5 pph and 30 pph; carbon black, which has an average particle size as measured by the iodine test of 20 to 100, between about 8 to about 70 pph; and
a sulfur-based curing agent; and
a printing face layer.

2. The printing blanket of claim 1 wherein the acrylonitrile-butadiene-isoprene terpolymer comprises at least about 30% by weight of acrylonitrile.

3. The printing blanket of claim 1 wherein the compressible layer comprises a homopolymer or copolymer of butadiene, a homopolymer or copolymer of isoprene, an acrylonitrile-butadiene-isoprene terpolymer, or a mixture thereof.

4. The printing blanket of claim 1 wherein the compressible layer comprises at least 30% by weight of the polymeric components of the acrylonitrile-butadiene-isoprene terpolymer.

5. The printing blanket of claim 1 wherein the compressible layer comprises at least 60% by weight of the polymeric components of the acrylonitrile-butadiene-isoprene terpolymer.

6. The printing blanket of claim 1 wherein the compressible layer further comprises between about 1 pph and about 20 pph of wood resins, between about 0.1 pph to about 10 pph of fatty acids, their salts, or mixtures thereof, and between about 2 pph and about 15 pph of a zinc-containing component.

7. The printing blanket of claim 1 wherein the sulfur-based curing agent forms crosslinks with the polymeric components, and wherein the sulfur-based curing agent produces greater than 50% of mono and disulfide crosslinks, with the balance being polysulfide crosslinks.

8. The printing blanket of claim 1 wherein the sulfur-based curing agent comprises sulfur at about 0.1 to about 3 pph; a dithiodimorpholine, a thiazole, a sulfenamide, or mixture thereof at about 0 1.5 to about 3.5 pph; and a thiuram, carbamate, or mixture thereof at about 1 to2pph.

9. The printing blanket of claim 1 wherein the compressible layer further comprises between about 1 pph and about 50 pph of butyl rubber, nitrile rubber, EPDM rubber, natural rubber, synthetic rubber, neoprene rubber, polysulfide rubber, polyvinyl chloride, polyurethane, or mixtures thereof.

10. The printing blanket of claim 1 wherein the compressible layer further comprises antioxidants, antiozonants, or a mixture thereof at between 1 to 9 pph.

11. A printing blanket comprising:
a metallic or polymeric inner sleeve;
an intetruediate compressible polymeric layer overlying the sleeve, wherein the compressible layer comprises an open or closed cell polymeric foam comprising an isoprene, an acrylonitrile-isoprene-butadiene terpolymer, or a mixture thereof, a crosslinking agent, a filler, and a sulfur-containing curing agent;
optionally a reinforcing layer overlying the compressible layer; and
an outer polymeric printing layer; wherein printing layer comprises a nitrile-butadiene copolymer, a hydrogenated nitrile-butadiene copolymer, a carboxylated nitrile-butadiene copolymer, a nitrile-butadiene-isoprene terpolymers, neoprene, isoprene, epoxidized isoprene, butyl, halogenated butyl, fluoroelastomers, polyurethane rubbers, or blends thereof.

12. The printing blanket of claim 11 wherein the compressible layer comprises expanded microspheres.

13. The printing blanket of claim 11 wherein the compressible layer comprises about 5 pph to about 30 pph aromatic oils which are at least partially polymerized into the composition, and between about 6 pph and about 10 pph of resins.

14. The printing blanket of claim 11 wherein the filler comprises carbon black fillers with a DBP # between about 80 to about 130 in an amount between about 13 to about 50 pph.

15. The printing blanket of claim 11 wherein the compressible layer comprises sulfur or sulfur-containing curing agents in an amount between about 1 pph to about 8 pph.

16. The printing blanket of claim 11 wherein the printing face layer, the compressible layer, or both further comprise 1 to 9 pph of antioxidants, antiozonants, or a mixture thereof.

17. The printing blanket of claim 11 wherein the printing face layer further comprises one or more of barite, silica, carbon black, and a wettability modifier.

18. The printing blanket of claim 11 wherein the compressible layer has a hardness of between about 50 and about 60, and a tensile strength of at least 1200 psi.

19. The printing blanket of claim 11 wherein the compressible layer has a tensile strength of at least 1800 psi.

20. The printing blanket of claim 11 wherein the compressible layer contains no wound thread.

21. A printing blanket comprising:
a sleeve;
a compressible layer including a open or closed-cell polymeric foam and comprising
polyisoprene, an acrylonitrile-isoprene copolymer, an acrylonitrile-isoprene-X terpolymer where X is another monomer, an acrylonitrile-X copolymer where X is another monomer, and an acrylonitrile-Y-X terpolymer where X and Y are monomers other than acrylonitrile, an acrylonitrile-butadiene-isoprene terpolymer, or a mixture thereof, wherein the acrylonitrile content of the copolymer or terpolymer is greater than 40%;
an aromatic oil in an amount of between about 5 pph and 30 pph; carbon black; and
a sulfur-based curing agent; and
a printing face layer.

22. A printing blanket comprising:
a metallic or polymeric printing sleeve;
a compressible layer including a open or closed-cell polymeric foam and comprising:
about 100 parts of an acrylonitrile-containing copolymer rubber;
microspheres present in an amount from about 1 to about 10 pph rubber;
a particulate filler present in an amount from about 10 to about 40 pph rubber;
a retarding agent present in an amount of not more than about 2 pph rubber;
one or more resins present in an amount from about 3 to about 29 pph rubber;
a non-crosslinked oil present in an amount from about 2 to about 25 pph rubber;
one or more antioxidants present in an amount not more than about 9 pph rubber;
one or more accelerators present in an amount from about 2 to about 14 pph rubber;
one or more activators present in an amount from about 2.5 to about 40 pph rubber;
a sulfur source present in an amount from about 0.25 to about 2.5 pph rubber; and
an acidic dispersant present in an amount of not more than about 4 pph rubber,
wherein the compressible layer composition is vulcanized to form the compressible layer and is disposed over the printing sleeve; and
a printing face disposed over the compressible layer.

23. The printing blanket of claim 22, wherein the compressible layer possesses:
a carbon black content from about 12 to about 28 pph rubber;
a phthalimide content from about 0.1 to about 1.5 pph rubber;
a resin content from about 10 to about 24 pph rubber;
a non-crosslinked oil content from about 10 to about 22 pph rubber;
a phenol content from about 0.1 to about 3 pph rubber;
a zinc 2-mercapto-toluimidazole content from about 0.1 to about 3 pph rubber;
a phenylenediamine content from about 0.1 to about 3 pph rubber;
an accelerator content from about 3 to about 11 pph rubber;
a sulfur content from about 1 to about 2.5 pph rubber;
a stearic acid content from about 0.1 to about 3 pph rubber;
an activator content from about 5 to about 15 pph rubber; or
a combination thereof.

24. The printing blanket of claim 22, wherein the acrylonitrile-containing copolymer possesses an acrylonitrile content from about 25% to about 41%.

25. The printing blanket of claim 24, wherein the acrylonitrile-containing copolymer possesses an acrylonitrile content from about 33% to about 37%.

26. The printing blanket of claim 24, wherein the acrylonitrile-containing copolymer comprises a terpolymer made from acrylonitrile and butadiene monomers, and in which each of the monomers are present in the terpolymer in an amount of at least about 25%.

27. The printing blanket of claim 26, wherein each of the monomers in the terpolymer are present in amounts of at least about 30% and in which the third monomer component is isoprene.

28. The printing blanket of claim 27, wherein the terpolymer comprises acrylonitrile in an amount from about 33% to about 37%, butadiene in an amount from about 30% to about 40%, and isoprene in an amount from about 30% to about 40%.

29. The printing blanket of claim 26, wherein the acrylonitrile-containing copolymer includes a mixture of acrylonitrile-containing copolymers, and wherein the mixture comprises at least about 50% of a terpolymer comprising acrylonitrile in an amount from about 33% to about 37%, butadiene in an amount from about 30% to about 40%, and isoprene in an amount from about 30% to about 40%.

30. The printing blanket of claim 22, wherein the printing face comprises:
a base of 100 parts of an acrylonitrile-containing rubber with between about 35% to about 50% by weight acrylonitrile content copolymerized with butadiene;
about 5 to about 50 pph of silica;
about 0.1 to about 15 pph of a coupling agent;
about 5 to about 60 pph of a processing oil;
at least about 0.1 pph of a sulfur-based curing agent;
about 1 to about 10 pph zinc oxide; and
about 1 to about 20 pph metal oxide, wherein the metal oxide comprises TiO₂, MgO, CaO, or a mixture thereof.

31. The printing blanket of claim 22, wherein the printing face comprises:
a base of 100 parts of nitrile rubber with between about 36% to about 45% by weight acrylonitrile copolymerized with at least butadiene;
a particulate filler at between about 5 pph to about 50 pph;
a coupling agent at a quantity of between about 0.5 to about 6 pph, wherein the coupling agent increases the surface adhesion of the particulate filler to the rubber;
a hydrophilic polymer with a molecular weight of at least about 400 and with at least one hydroxyl moiety per 100 molecular weight at between about 5 to about 35 pph;
a factice at about 5 to about 40 pph;
sulfur at about 0.5 to about 3 pph;
a primary accelerator at about 0.1 to about 4 pph;
zinc oxide at about 2.5 to about 30 pph; and
a metal oxide selected from the group consisting of TiO₂, MgO, and/or CaO, at about 1 to about 10 pph,
wherein the composition is vulcanized to form the printing face layer.

32. The printing blanket of claim 22, wherein the printing face comprises:
about 100 parts of nitrile rubber with an average acrylonitrile content from about 36% to about 40% by weight;
from about 5 to about 50 parts silica;
from about 0.5 to about 6 of an organosilane;
from about 2 to about 10 parts of a tackifying resin;
from about 5 to about 40 parts of a crosslinked vegetable oil
from about 5 to about 35 parts of a hydrophillic polymer;
from about 2.5 to about 30 parts of a metal oxide;
from about 0.5 to about 4 parts of a fatty acid; and
from about 0.5 to about 3 parts sulfur.

33. The printing blanket of claim 32, wherein the blanket is substantially free of polysulfide polymer, and wherein the printing face layer possesses a tensile strength of greater than 1000 pounds per square inch.

34. The printing blanket of claim 22, wherein the printing face comprises:
a base of 100 parts of nitrile rubber with between 38% to about 45% by weight acrylonitrile;
a particulate filler at between about 5 pph to about 50 pph;
a coupling agent at a quantity of between about 0.5 to about 6 pph;
at least one wettability modifier in an amount sufficient to increase the hydrophilicity of the printing face layer;
a factice at about 5 to about 40 pph;
sulfur at about 0.5 to about 3 pph;
a primary accelerator at about 0.1 to about 4 pph;
from about 0.5 to about 4 parts of a fatty acid; and
zinc oxide at about 2.5 to about 30 pph,
wherein the composition is vulcanized to form the printing face layer.

35. The printing blanket of claim 30, further comprising an adhesive layer comprising:
about 100 parts of at least one nitrile rubber copolymer having an acrylonitrile content from about 25% to about 41%
a particulate filler content from about 5 to about 50 pph rubber;
a non-vulcanized oil content from about 5 to about 40 pph rubber;
an organosilane content from about 0.5 to about 3 pph rubber;
a pigment content from about 1.5 to about 3.pph rubber;
an antioxidant content from about 0.5 to about 6 pph rubber;
an accelerator content from about 0.6 to about 13 pph rubber;
a sulfur content from about 0.5 to about 10 pph rubber;
an activator content from about 1 to about 16 pph rubber; or
a combination thereof,
wherein the adhesive layer is disposed between the compressible layer and the printing face layer, or wherein the adhesive layer is disposed between the printing sleeve and the compressible layer.

36. The printing blanket of claim 30, further comprising a reinforcing layer comprising:
about 100 parts of an acrylonitrile-containing copolymer;
a particulate filler present in an amount from about 10 to about 40 pph rubber;
a retarding agent present in an amount of not more than about 2 pph rubber;
one or more resins present in an amount from about 3 to about 29 pph rubber;
a non-crosslinked oil present in an amount from about 2 to about 25 pph rubber;
one or more antioxidants present in an amount not more than about 9 pph rubber;
one or more accelerators present in an amount from about 2 to about 14 pph rubber;
one or more activators present in an amount from about 2.5 to about 40 pph rubber;
a sulfur source present in an amount from about 0.25 to about 2.5 pph rubber; and
an acidic dispersant present in an amount of not more than about 4 pph rubber,
wherein the reinforcing layer composition is vulcanized to form the reinforcing layer and is disposed over the compressible layer and below the printing face layer.

37. The printing blanket of claim 36, further comprising an adhesive layer comprising:
about 100 parts of at least one nitrile rubber copolymer having an acrylonitrile content from about 25% to about 41%
a particulate filler content from about 5 to about 50 pph rubber;
a non-vulcanized oil content from about 5 to about 40 pph rubber;
an organosilane content from about 0.5 to about 3 pph rubber;
a pigment content from about 1.5 to about 30 pph rubber;
an antioxidant content from about 0.5 to about 6 pph rubber;
an accelerator content from about 0.6 to about 13 pph rubber;
a sulfur content from about 0.5 to about 10 pph rubber;
an activator content from about 1 to about 16 pph rubber; or
a combination thereof,
wherein the adhesive layer is disposed between the compressible layer and the reinforcing layer, or wherein the adhesive layer is disposed between the reinforcing layer and the printing face layer.
